(19) United States
(12) Patent Application Publication
(10) Pub. No.: US 2011/0175985 A1
(43) Pub. Date: Jul. 21, 2011

(54) METHOD OF GENERATING CONTENTS INFORMATION AND APPARATUS FOR MANAGING CONTENTS USING THE CONTENTS INFORMATION

(75) Inventors: Kug Jin Yun, Daejeon (KR); Nam Ho Hur, Daejeon (KR); Bong Ho Lee, Daejeon (KR); Hyun Lee, Daejeon (KR); Jin Woong Kim, Daejeon (KR); Soo In Lee, Daejeon (KR); Yoon-Jin Lee, Gyeonggi-do (KR); Young-Kown Lim, Gyeonggi-do (KR)

(73) Assignee: ELECTRONICS AND TELECOMMUNICATIONS RESEARCH INSTITUTE, Daejeon (KR)

(21) Appl. No.: 12/673,604

(22) PCT Filed: Aug. 20, 2008
(86) PCT No.: PCT/KR2008/004858

§ 371 Date: Feb. 16, 2010

(30) Foreign Application Priority Data
Aug. 21, 2007 (KR) 10-2007-0083985

(51) Int. Cl. H04N 13/02

(52) U.S. Cl. 348/47; 348/46; 348/E13.074

(57) ABSTRACT

The present invention relates to a method of generating contents information for managing contents including stereo-scopic contents being two-dimensional contents and three dimensional contents, and an apparatus for managing contents, the method including the steps of, when there is a scene change of contents, adding a second field including information on each of a plurality of scenes corresponding to a plurality of types, respectively, to the contents information.

### TECHNICAL FIELD

The present invention relates to a method of generating contents information, and more particularly, to a method of generating a stereoscopic descriptor, which is contents information for managing contents including stereoscopic contents, which can be two-dimensional or three-dimensional contents, and an apparatus for managing contents using the stereoscopic descriptor.

The present invention is derived from a study that was supported by the IT R&D program of MIC/IITA [2007-S-004-01, Development of Glassless Single-User 3D Broadcasting Technologies].

### BACKGROUND ART

In order to transfer contents based on MPEG-4, an initial object descriptor (IOD), a binary format for scene (BIFS), an object descriptor (OD), and media data are needed.

The initial object descriptor, which is data first transferred from an MPEG-4 session, is a descriptor having information on the binary format for scene stream or the object descriptor stream.

The contents include several media objects, such as a still image, a text, a motion picture, audio, or the like, wherein the binary format for scene stream represents a spatial position and a temporal relation between the media objects.

The object descriptor is a descriptor including information required for the relationship and decoding of the binary format for scene stream and the media objects

However, the object descriptor of MPEG-4 focuses on the management of a two-dimensional motion picture, so that it cannot manage a three-dimensional motion picture

Therefore, as a method of managing a motion picture using an object descriptor supporting a three-dimensional motion picture, in the related art, there is an apparatus for managing three-dimensional picture using information and structure of MPEG-4 object descriptor.

The apparatus proposes a structure of an object descriptor including information on the number of media streams according to a kind of a three-dimensional motion picture (information representing whether an image is a stereoscopic three-dimensional motion picture or a multiview three-dimensional motion picture), a display mode (two-dimensional/field shuttering/frame shuttering/polarizer display modes for the stereoscopic three-dimensional motion picture and two-dimensional/panorama/stereo display modes for the multiview three-dimensional motion picture), the number of cameras, the number of views, and the number of media streams according to the views, and provides an apparatus for managing a three-dimensional motion picture using an object descriptor with the structure.

However, there is a problem in that it is impossible to manage contents composed of two-dimensional contents and three-dimensional contents or various types of three-dimensional contents, in the related art.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

An object of the present invention is to provide a method of generating contents information and an apparatus for managing contents using the contents information having advantages of managing contents composed of two-dimensional contents and three-dimensional contents, or various types of three-dimensional contents.

### Technical Solution

To achieve the technical, object, an exemplary embodiment of the present invention provides a method of generating contents information including adding a first field representing the number of scene changes of contents to contents information, and adding a second field including information on each of a plurality of scenes corresponding to a plurality of types, respectively, to the contents information, when there is a scene change of contents.

To achieve the technical object, another embodiment of the present invention provides a method of generating contents information including adding a first field representing the number of scene changes of contents to contents information, and adding a second field including information on a contents type to the contents information when there is no scene change of contents.

To achieve the technical object, yet another embodiment of the present invention provides an apparatus for managing contents including: a control signal generating unit that generates a binary format for a scene descriptor, an object descriptor, and a stereoscopic descriptor; an encoding unit that encodes media data and control signals input from the control signal generating unit and outputs an encoding stream (elementary stream, ES); and a unit that generates a file after receiving the encoding stream, the stereoscopic descriptor including information required for decoding and reproducing the contents composed of two-dimensional contents and three-dimensional contents, or various types of three-dimensional contents.

### Advantageous Effects

According to an exemplary embodiment of the present invention, it is possible to manage, using the stereoscopic descriptor, contents composed of two-dimensional contents and three-dimensional contents or various types of three-dimensional contents, and to automatically turn on/off a barrier using a start frame index and contents format information included in the stereoscopic descriptor in a three-dimensional (3D) terminal.

### BRIEF DESCRIPTION OF THE DRAWINGS

FIG. 1 illustrates configuration of contents that are provided by an apparatus for managing contents according to an exemplary embodiment of the present invention.

FIG. 2 is a view showing an apparatus for managing contents using a stereoscopic descriptor according to an exemplary embodiment of the present invention.

FIG. 3 is a view showing an apparatus for reproducing contents using a stereoscopic descriptor according to an exemplary embodiment of the present invention.

FIG. 4 is a flowchart illustrating a method of generating a stereoscopic descriptor according to an exemplary embodiment of the present invention.

FIG. 5 is a view showing a structure and components of a stereoscopic descriptor according to an exemplary embodiment of the present invention when contents are composed of two-dimensional contents and three-dimensional contents, or various types of three-dimensional contents.

FIG. 6 is a view showing a structure and components of a stereoscopic descriptor according to an exemplary embodiment of the present invention in the case where contents are configured by a single type.

FIG. 7 shows the types of 3D contents.

FIG. 8 illustrates parallel and cross arrangements of cameras.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise”, and variations such as “comprises” and “comprising”, will be understood to imply the inclusion of stated elements but not the exclusion of any other elements. In addition, the terms “-er” and “-or” described in the specification mean units for processing at least one function and operation and can be implemented by hardware components, software components, and, combinations thereof.

First, the configuration of contents that are provided by an apparatus for managing contents using a stereoscopic descriptor according to an exemplary embodiment of the present invention will be described. The contents include a motion picture and a still image.

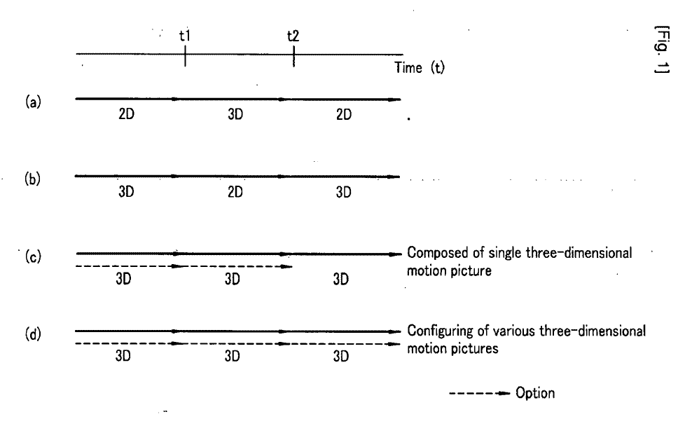

FIG. 1 is a view showing the configuration of contents that are provided by an apparatus for managing contents according to an exemplary embodiment of the present invention.

In FIG. 1, the horizontal axis represents time, and “2D” means two-dimensional contents and “3D” means three-dimensional contents.

In FIG. 1, (a) to (d) show the types of contents transferred over time with respect to configuration forms of respective contents

(a) of FIG. 1 shows a form composed of three-dimensional contents only in a specific time and two-dimensional contents in the remaining time. In other words, the configuration of (a) of FIG. 1 is composed of three-dimensional contents only from t1 time to t2 time and two-dimensional contents in the remaining time.

(b) of FIG. 1 shows a form composed of three-dimensional contents only in a specific time and two-dimensional contents in the remaining time. In other words, the configuration of (b) of FIG. 1 is composed of three-dimensional contents only from t1 time to t2 time and two-dimensional contents in the remaining time.

(c) of FIG. 1 shows a form composed of a single type of three-dimensional contents.

At this time, the three-dimensional contents include a left image and a right image, wherein the left image and the right image can be provided from one source and two sources. In (c) and (d) of FIG. 1, an option shows a case where the left image and the right image are provided from the two sources.

(d) of FIG. 1 shows a form composed of various types of three-dimensional contents.

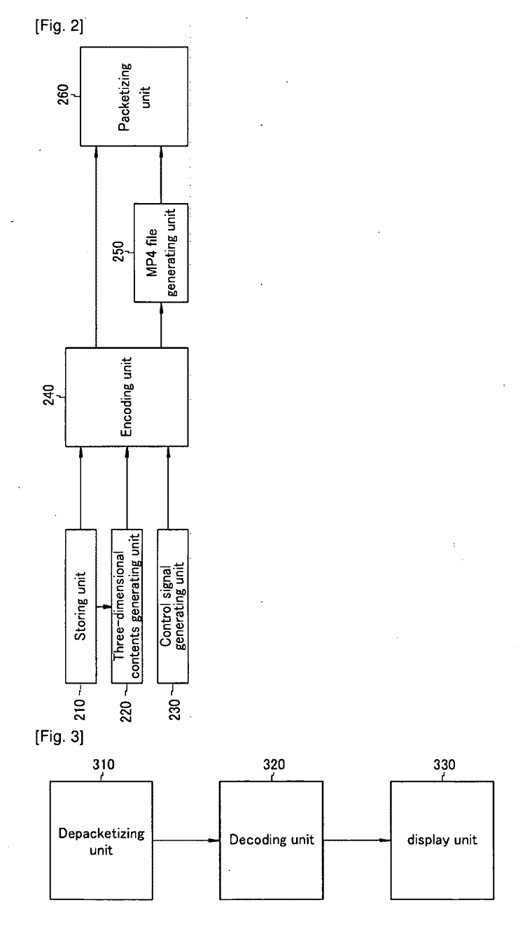

Next, an apparatus for managing contents and an apparatus for reproducing contents using a stereoscopic descriptor according to an exemplary embodiment of the present invention will be described with reference to FIG. 2 and FIG. 3. FIG. 2 is a view showing an apparatus for managing contents using a stereoscopic descriptor according to an exemplary embodiment of the present invention, and FIG. 3 is a view showing an apparatus for reproducing contents using a stereoscopic descriptor according to an exemplary embodiment of the present invention.

As shown in FIG. 2, an apparatus for managing contents according to an exemplary embodiment of the present invention includes a storing unit 210, a three-dimensional contents generating unit 220, a control signal generating unit 230, an encoding unit 240, an MP4 file generating unit 250, and a packetizing unit 260.

The storing unit 210 stores contents obtained by a camera and the three-dimensional generating unit 220 generates the three-dimensional contents by converting the sizes and colors of images transferred from the storing unit 210.

The control signal generating unit 230 generates a binary format for a scene descriptor, an object descriptor, and a stereoscopic descriptor in MPEG-4. The stereoscopic descriptor includes information required for decoding and reproducing contents when the contents are composed of two-dimensional contents and three-dimensional contents, or various types of three-dimensional contents.

The encoding unit 240 encodes two-dimensional contents input from the storing unit 210, three-dimensional contents input from the three-dimensional contents generating unit 220, and MPEG-4 control signals input from the control signal generating unit 230, and outputs each encoding stream (elementary stream, ES).

The MP4 file generating unit 250 receives each encoding stream and generates the MP4 file defined in MPEG-4 system specifications.

The packetizing unit 260 extracts media data and MPEG-4 control signals included in the MP4 file after receiving the MP4 file from the MP4 file generating unit 250 and then generates packets defined in the MPEG-4 system specifications, or extracts the media data and the MPEG-4 control signals after receiving the encoding stream from the encoding unit 240 and then generates packets defined in the MPEG-4 system specifications, which in turn transmits them through a network.

As shown in FIG. 3, the apparatus for reproducing contents according to an exemplary embodiment of the present invention includes a depacketizing unit 310, a decoding unit 320, and a display unit 330.

The depacketizing unit 310 receives the received MPEG-4 packet to recover the media data. The decoding unit 320 decodes the recovered media data in the depacketizing unit 310 to recover contents.

The display unit 330 displays the recovered contents.

A pseudo code representing the stereoscopic descriptor according to an exemplary embodiment of the present invention will now be described. Tables 1 to 3 show examples of the pseudo codes representing the stereoscopic descriptor according to an exemplary embodiment of the present invention.

First, reviewing Table 1, StereoScopicDescrTag represents a stereoscopic descriptor tag. As shown in Table 1, if Scene_change_number being a variable representing the number of scene changes is not 0, the stereoscopic descriptor includes ScenechangeSpecificInfo, and if the Scene_change_number is 0, the stereoscopic descriptor includes 3-bit Contents_format. Further, the stereoscopic descriptor includes 1-bit StereoscopicCamera_setting, 4-bit Reserved, 16-bit Baseline, 16-bit Focal_Length, 16-bit ConvergencePoint_distance, 16-bit Max_disparity, and 16-bit Min_disparity.

The ScenechangeSpecificInfo includes 16-bit Start_AU_index, 3-bit Contents_format, 5-bit Reserved, and DecoderSpecificInfo.

As shown in Table 2, the stereoscopic descriptor includes the ScenechangeSpecificInfo and the Contents_format regardless of the Scene_change_number and may allow a user to designate the structure of the ScenechangeSpecificInfo, rather than previously designate it.

Further, as in Table 3, the StereoscopicCamera_setting, the Reserved, the Baseline, the Focal_Length, and the ConvergencePoint_distance may be represented to be included in StereoscopicCameraInfo being a separate field and the Max_disparity and the Min_disparity may be represented to be included in StereoscopicContentsInfo being a separate field.

The meanings of each parameter and field will be described below.

TABLE 1

Class StereoScopic_descriptor extends BaseDescriptor:bit 8
tag= StereoScopicDescrTag{
bit 16 Scenechange_number;
if(Scene_change_number){
ScenechangeSpecificInfo[0 • • • 255]
}else{
bit 3 Contents_format;}
bit 1 StereoscopicCamera_setting;
bit 4 Reserved=1111;
bit 16 Baseline;
bit 16 Focal_Length;
bit 16 ConvergencePoint_distance;
bit 16 Max_disparity;
bit 16 Min_disparity;

ScenechangeSpecificInfo{

bit 16 Start_AU_index
bit 3 Contents_format
bit 5 Reserved
bit nx8 DecoderSpecificInfo[0...1]
}

TABLE 2

Class StereoScopic_descriptor extends BaseDescriptor:bit 8
tag= StereoScopicDescrTag{
ScenechangeSpecificInfo[0 • • • 255]
bit 3 Contents_format;
bit 1 StereoscopicCamera_setting;
bit 4 Reserved=1111;
bit 16 Baseline;
bit 16 Focal_Length;
bit 16 ConvergencePoint_distance;
bit 16 Max_disparity;
bit 16 Min_disparity;
}

TABLE 3

Class StereoScopic_descriptor extends BaseDescriptor:bit 8
tag= StereoScopicDescrTag{
bit 16 Scenechange_number;
if(Scene_change_number){
ScenechangeSpecificInfo[0...255]
}else{
bit 3 Contents_format;}
StereoscopicCameraInfo[0...1];
StereoscopicContentsInfo[0...1];
}

ScenechangeSpecificInfo{

bit 16 Start_AU_index
bit 3 Contents_format
bit 5 Reserved
bit nx8 DecoderSpecificInfo[0...1]
}

StereoscopicCameraInfo{

bit 1 StereoscopicCamera_setting;
bit 4 Reserved=1111;
bit 16 Baseline;
bit 16 Focal_Length;
bit 16 ConvergencePoint_distance;
}

StereoscopicContentsInfo{

bit 16 Max_disparity;
bit 16 Min_disparity;
}

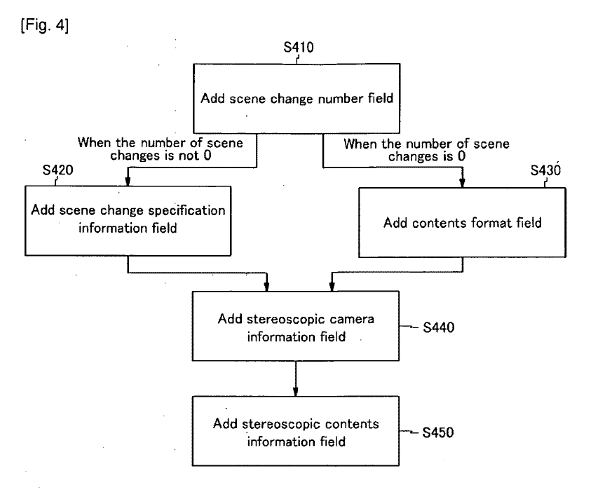

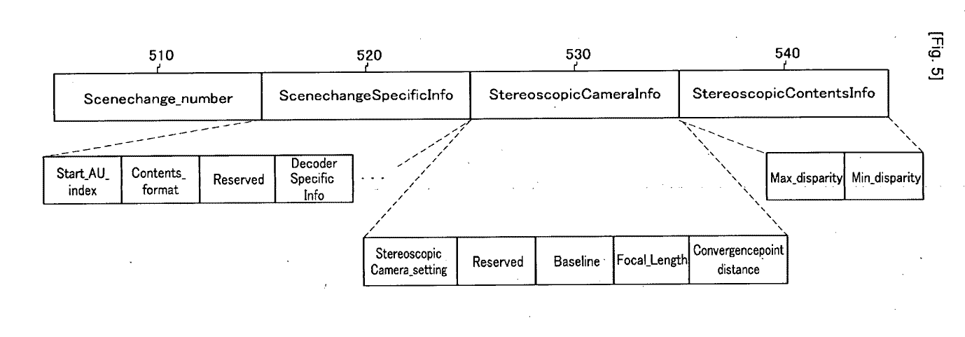

A method of generating a stereoscopic descriptor according to an exemplary embodiment of the present invention will now be described with reference to FIG. 4 to FIG. 8.

FIG. 4 is a flowchart illustrating a method of generating a stereoscopic descriptor according to an exemplary embodiment of the present invention.

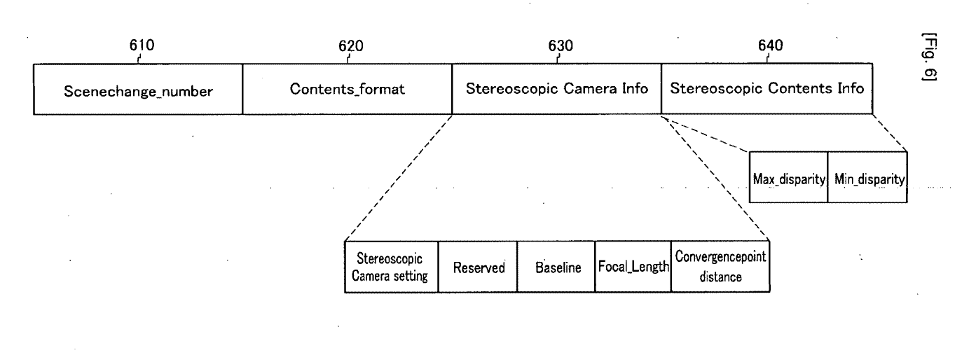

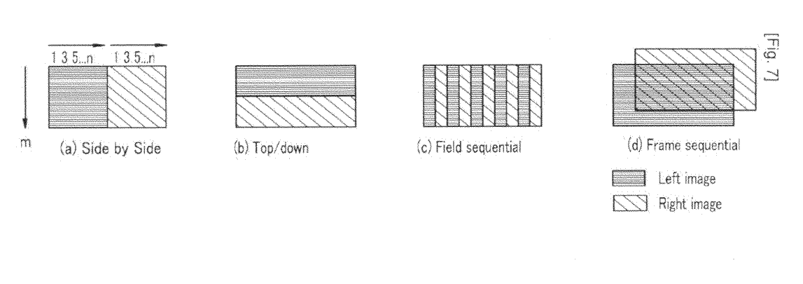

FIG. 5 is a view showing a structure and components of a stereoscopic descriptor according to an exemplary embodiment of the present invention when the contents are composed of two-dimensional contents and three-dimensional contents, or various types of three-dimensional contents, and FIG. 6 is a view showing a structure and components of a stereoscopic descriptor according to an exemplary embodiment of the present invention when contents are formed in one type. The structure of the stereoscopic descriptor according to an exemplary embodiment of the present invention can be applied to all systems for servicing MPEG-2/MPEG-4 system-based stereoscopic contents, but MPEG-2/MPEG-4 system specifications do not support the stereoscopic descriptor.

First, the control signal generating unit 230 adds Scenechange_number fields 510 and 610 (S410). The number of scene changes represents the changed number of contents type when the contents are composed of two-dimensional contents and three-dimensional contents, or various types of three-dimensional contents. The scene means a unit in which the same contents type is transferred.

For example, the contents of FIGS. 1a, 1b, and 1d are composed of three scenes, wherein the number of scene changes is 2. The contents of FIG. 1c are composed of one scene, wherein the number of scene changes is 0.

When the number of scene changes is not 0, that is, the contents are composed of a plurality of scenes in which two-dimensional and three-dimensional contents are mixed, or various types of three-dimensional contents are mixed, the control signal generating unit 230 adds a scene change specification information (ScenechangeSpecificInfo) field 520 (S420).

The scene change specification information field 520, which is a field including information on each of the plurality of scenes, includes the start frame index (Start_AU_index), the contents format (Contents_format), the reserved (Reserved), and the decoder specification information (DecoderSpecificInfo) parameters for each of a plurality of scenes, as shown in FIG. 5.

The start frame index parameter represents the access unit (AU) number of each scene. AU is generally a frame.

The contents format parameter is a parameter representing the types of contents.

Table 4 represents an example of a contents format parameter value. Mono means a general 2D motion picture type.

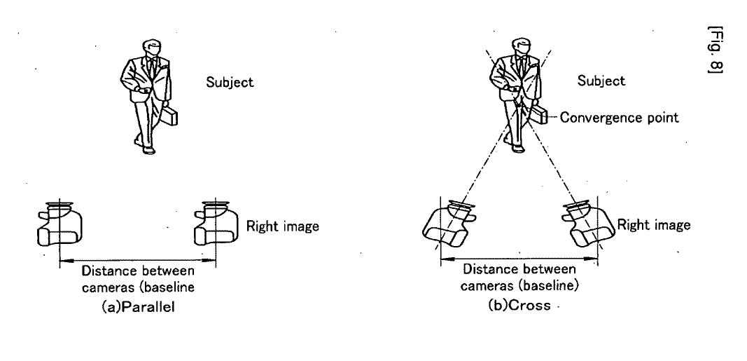

The types of 3D contents will be described with reference to FIG. 7

FIG. 7 is a view showing the types of 3D contents. The stereoscopic contents include a left image and a right image, wherein side by side means a form that the left image and the right image enter one frame left and right as shown in (a) of FIG. 7.

Here, “n” means horizontal image sizes for the right image and the left image, respectively, and “m” means vertical image sizes.

Top/down means a form in which the left image and the right image are arranged up and down in a frame as shown in (b) of FIG. 7.

As shown in (c) of FIG. 7, field sequential means a form in which the fields of the left image and the right image are alternately arranged in a frame

That is, the frame is formed in order of “a 1^{st} vertical line of a left image, a 2^{nd} vertical line of a right image, a 3^{rd} vertical line of a left image, a 4^{th} vertical line of a right image . . . ”.

As shown in (d) of FIG. 7, the frame sequential means a form in which the frame of the left image and the frame of the right image are alternately transferred In other words, the frame is transferred in order of “a 1^{st} frame of a left image, a 1^{st} frame of a right image, a 2^{nd} frame of a left image, a 2^{nd} frame of a right image . . . ”.

A main + additional image or a depth/disparity map is a form configuring data by considering any one of the left image and the right image as a main image and the other as a sub image, or configuring data by considering the left image or the right image as a main image and adding a depth/disparity map.

The depth/disparity map can generate the stereoscopic image using the left image or the right image, and the depth/disparity map as the information obtained through a separate signal processing using the obtained left and right images.

The depth/disparity map, has an advantage of having a smaller data amount than the image form.

TABLE 4

| | value | description |
|---|---|---|
| 2D | 000 | Mono |
| 3D | 001 | Sidebyside |
| | 010 | Top/down |
| | 011 | Field sequential |
| | 100 | Frame sequential |
| | 101 | Main + additional image or depth/disparity map |
| | 110- | Reserved |

The reserved (Reserved), which is a reserved bit, is an inserted bit so as to meet 16 bits.

The decoder specification information (DecoderSpecificInfo) parameter includes header information required for decoding contents.

At this time, when the 3D contents header is the same as the existing 2D contents header, it is not written. That is, if it has the same header information, the header information is not written repetitively.

For example, the scene change specification information field 520 of the stereoscopic descriptor of the contents having the form shown in FIG. 1a includes [0,000,11111, 2D contents header/3600,001,11111, 3D contents header/5800,000,11111, 2D contents header].

A general MPEG-4 system can transfer the header information required for decoding in the case where the contents are composed of only two-dimensional contents or a single type of three-dimensional contents, but cannot transfer the header information required for decoding when the contents are composed of two-dimensional contents and three-dimensional contents, or various types of three-dimensional contents. However, an exemplary embodiment of the present invention can transfer the header information required for decoding by using the stereoscopic descriptor including the scene change specification information field 520 as described above, when the contents are composed of two-dimensional contents and three-dimensional contents, or various types of three-dimensional contents.

In a 3D terminal, when 3D contents are activated in the binary format for scene descriptor based on the start frame index and the contents format information, a barrier can automatically be on/off.

The barrier is attached on an LCD to separate the stereoscopic image, making it possible to perform a role of seeing the left image with a left eye and the left image with a right eye.

When the number of scene changes is 0, the control signal generating unit 230 adds a contents format field 620 (S430). In other words, in the case where the contents is composed of only two-dimensional contents or a single type of three-dimensional contents, the stereoscopic descriptor includes the contents format field but does not include the start frame index (Start_AU_index), the reserved (Reserved), the decoder specification information (DecoderSpecificInfo).

Next, the control signal generating unit 230 adds stereoscopic camera information

(StereoscopicCameraInfo) fields 530 and 630 (S440).

The stereoscopic camera information fields 530 and 630, which are fields including information on a stereoscopic camera, include stereoscopic camera setting (StereoscopicCamera_setting), reserved (Reserved), baseline (Baseline), focal length (Focal_Length) and convergence point distance (ConvergencePoint_distance) paramters.

The stereoscopic camera setting, which represents an arrangement form of a camera upon producing or photographing three-dimensional contents, is divided into a parallel and a cross arrangement.

FIG. 8 shows parallel and cross arrangements of cameras. As shown in (a) of FIG. 8, two cameras are arranged in parallel in the parallel arrangement, and as shown in (b) of FIG. 8, cameras are arranged such that the photographing directions cross each other at an object in the cross arrangement.

The baseline represents a distance between two cameras and the focal length represents a distance from a lens to an image plane. The image plane is generally a film on which the image is formed.

The convergence point distance represents a distance from the baseline to the convergence point, wherein the convergence point means a point crossly meeting at a subject.

The control signal generating unit 230 adds (S450) stereoscopic contents information

(StereoscopicContentsInfo) fields 540 and 640.

The stereoscopic contents information fields, which are fields including information on the disparity of the stereoscopic contents, include Max_disparity and Min_disparity parameters. The disparity leads to a difference in images obtained from two cameras. In other words, a specific point (subject) of the left image is at a slightly different position in the right image. The difference in the image is referred to as the disparity and the information representing the disparity value is referred to as a magnitude of the disparity.

The Max disparity represents a magnitude of the Max disparity of the three-dimensional contents and the Min disparity represents a magnitude of the Min disparity of the three-dimensional contents.

The above-mentioned exemplary embodiments of the present invention are not embodied only by a method and apparatus. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of generating contents information comprising:
adding a first field representing the number of scene changes of contents to contents information; and
adding a second field including information on each of a plurality of scenes corresponding to a plurality of types to the contents information, respectively, when there is the scene change of contents.

2. The method of claim 1, wherein the second field includes information on a start frame of each of the plurality of scenes, and information on the plurality of types each corresponding to the plurality of scenes.

3. The method of claim 2, wherein the second field further includes a plurality of header information required for decoding each of the plurality of scenes and corresponding to each of the plurality of scenes.

4. The method of claim 1, further comprising adding a third field including information on a camera photographing the contents to contents information.

5. The method of claim 4, wherein the third field includes:
information on the type of arrangement of a plurality of cameras photographing the contents;
information on a baseline that is a distance between the plurality of cameras;
information on a focal length that is a distance between lenses of the plurality of cameras and an image plane; and
information on a distance between the baseline and a convergence point.

6. The method of claim 1, further comprising adding a fourth field including information on a disparity between the contents of the plurality of scenes and the contents information.

7. The method of claim 6, wherein the fourth field includes:
information on a magnitude of the Max disparity between the contents of the plurality of scenes; and
information on a magnitude of the Min disparity between the contents of the plurality of scenes

8. A method of generating contents information comprising:
adding a first field representing the number of scene changes of contents to contents information; and
adding a second field including information on the types of contents to the contents information, when there is no scene change of contents.

9. The method of claim 8, further comprising adding a third field including information on a camera photographing the contents.

10. The method of claim 9, wherein the third field includes:
information on the type of arrangement of a plurality of cameras photographing the contents;
information on a baseline that is a distance between the plurality of cameras;
information on a focal length that is a distance between lenses of the plurality of cameras and an image plane; and
information on a convergence point that is a distance between the baseline and a convergence point.

11. An apparatus for managing contents comprising:
a control signal generating unit generating a binary format for a scene descriptor,
an object descriptor, and a stereoscopic descriptor;
an encoding unit encoding media data and control signals input from the control signal generating unit and outputting an encoding stream (elementary stream, ES); and
a unit generating a file after receiving the encoding stream, wherein
the stereoscopic descriptor includes information required for decoding and reproducing the contents composed of two-dimensional contents and three-dimensional contents, or various types of three-dimensional contents.

12. The apparatus of claim 11, further comprising a packetizing unit extracting the media data and the control signals included in the file and generating packets.

13. The apparatus of claim 11, wherein the stereoscopic descriptor includes a scene change specification information field on each of a plurality of scenes corresponding to a plurality of types, respectively.

14. The apparatus of claim 13, wherein the scene change specification information field includes:
a plurality of start frame index parameters representing each start access unit (AU) of the plurality of scenes;
a plurality of contents format parameters representing each content type of the plurality of scenes; and
a plurality of decoder specification information parameters including header information required for decoding each contents of the plurality of scenes.

15. The apparatus of claim 13, wherein the stereoscopic descriptor further includes a stereoscopic camera information field including information on a stereoscopic camera.

16. The apparatus of claim 15, wherein the stereoscopic camera information field includes:
a stereoscopic camera setting parameter representing an arrangement form of a plurality of cameras photographing three-dimensional contents;
a baseline parameter representing a baseline that is a distance between the plurality of cameras;
a focal length parameter representing a distance between lenses of the plurality of cameras and an image plane; and
a convergence point distance representing a distance between the baseline and a convergence point.

17. The apparatus of claim 13, wherein the stereoscopic descriptor further includes a stereoscopic contents information field including information on a disparity between contents of the plurality of scenes.

18. The apparatus of claim 17, wherein the stereoscopic contents information field includes:
a Max disparity parameter representing a magnitude of a Max disparity between contents of the plurality of scenes; and
a Min disparity parameter representing a magnitude of a Min disparity between contents of the plurality of scenes.

19. The apparatus of claim 11, further comprising a three-dimensional contents generating unit converting sizes and colors of contents into three-dimensional contents.
